(19) United States
(12) Patent Application Publication
(10) Pub. No.: US 2025/0219134 A1
(43) Pub. Date: Jul. 3, 2025

(54) SULFIDE-BASED SOLID ELECTROLYTE

(71) Applicant: Solid Power Operating, Inc., Louisville, CO (US)

(72) Inventors: Brian E. FRANCISCO, Arvada, CO (US); Dinesh K. AMARASINGHE, Louisville, CO (US)

(21) Appl. No.: 19/005,486

(22) Filed: Dec. 30, 2024

Related U.S. Application Data
(60) Provisional application No. 63/616,473, filed on Dec. 29, 2023.

(51) Int. Cl. H01M 10/0562

(52) U.S. Cl. CPC H01M 10/0562; H01M 2300/008

(57) ABSTRACT

The present disclosure provides an electrolyte composition. The disclosure also generally relates to solid state batteries, and electrolyte compositions that may be used in solid state batteries. The disclosure also provides an electrolyte composition comprising lithium, phosphorous, and/or sulfur. The composition may further include a halogen. Without being bound by theory, the disclosure also provides an electrolyte composition comprising a novel x-ray diffraction (XRD) pattern.

### CROSS-REFERENCE TO RELATED APPLICATION

This application is related to and claims priority under 35 U.S.C. § 119 (e) from U.S. Patent Application No. 63/616,473, filed Dec. 29, 2023, titled “Sulfide-Based Solid Electrolyte,” the entire contents of which is incorporated herein by reference for all purposes.

### FIELD OF THE DISCLOSURE

The present disclosure is related to sulfide-based solid electrolytes and methods of making the sulfide-based solid electrolytes.

### BACKGROUND

As technologies around Li ion batteries using liquid electrolytes reaches maturity, institutions are turning to solid-state batteries to push battery technology further. Solid-state batteries replace the liquid electrolytes with solid ionically conductive material that are used in forming the negative electrode, positive electrode and separator layers withing the battery. Of the types of solid electrolyte materials available, the sulfide class of solid electrolytes has drawn interest due to having a high ionic conductivity and processability when forming battery components.

It is with these observations in mind, among others, that aspects of the present disclosure were conceived.

### SUMMARY

The present disclosure relates to a solid electrolyte.

Provided herein is an electrolyte composition comprising lithium, phosphorous, and sulfur. The electrolyte composition comprises an x-ray diffraction (XRD) peak at 2θ=15.39°±0.5°, 27.60°±0.5°, 30.92°±0.5°, or 33.28°±0.5°.

In some embodiments, the composition exhibits an XRD pattern having peaks at 2θ=15.39°±0.5°, 27.60°±0.5°, 30.92°±0.5°, and 33.28°±0.5°.

The composition may further include a halogen. The halogen may be F, CI, Br, or I. The composition may further include LiCl.

In some embodiments, the composition comprises the formula Li_{5+z}P₃S₁₀Cl_{z}, where 0≤z≤5.

In some embodiments, the composition comprises an XRD peak 2θ at one or more of 11.45°±0.5°, 16.43°+0.5°, 19.33°±0.5°, and 23.02°±0.5°. In some embodiments, the composition comprises an XRD peak 2θ at two or more of 11.45°±0.5°, 16.43°±0.5°, 19.33°±0.5°, and 23.02°±0.5°. In some embodiments, the composition comprises an XRD peak 2θ at three or more of 11.45°±0.5°, 16.43°±0.5°, 19.33°±0.5°, and 23.02°±0.5°. In some embodiments, the composition comprises an XRD peak 2θ at 11.45°±0.5°, 16.43°±0.5°, 19.33°±0.5°, and 23.02°±0.5°.

In some embodiments, the composition comprises an XRD peak 2θ at one or more of 15.39°±0.5°, 27.60°±0.5°, 30.92°±0.5°, and 33.28°±0.5°. In some embodiments, the composition comprises an XRD peak 20 at two or more of 15.39°±0.5°, 27.60°±0.5°, 30.92°±0.5°, and 33.28°±0.5°. In some embodiments, the composition comprises an XRD peak 2θ at three or more of 15.39°±0.5°, 27.60°±0.5°, 30.92°±0.5°, and 33.28°±0.5°.

In some embodiments, the electrolyte comprises an XRD peak at 2θ=11.45°±0.5°. In some embodiments, the electrolyte comprises an XRD peak at 2θ=16.43°±0.5°. In some embodiments, the electrolyte comprises an XRD peak at 2θ=19.33°±0.5°. In some embodiments, the electrolyte comprises an XRD peak at 2θ=23.02°±0.5°.

In some embodiments, the composition comprises an XRD peak at 2θ=15.39°±0.3°, 27.60°±0.3°, 30.92°±0.3°, and 33.28°±0.3°. In some embodiments, the composition comprises an XRD peak 2θ at one or more of 11.45°±0.3°, 16.43°±0.3°, 19.33°±0.3°, and 23.02°±0.3°. In some embodiments, the composition comprises an XRD peak at 2θ=15.39°±0.1°, 27.60°±0.1°, 30.92°±0.1°, and 33.28°±0.1°. In some embodiments, the composition comprises an XRD peak 2θ at one or more of 11.45°±0.1°, 16.43°±0.1°, 19.33°±0.1°, and 23.02°±0.1°.

The present disclosure further relates to a method of making an electrolyte composition comprising lithium, phosphorous, and sulfur with formula Li_{5+z}P₃S₁₀X_{z}. The method comprises mixing Li₂S, P₂S₅, sulfur, and LiX in the presence of a solvent. In some embodiments, X comprises a halogen. In some embodiments, z ranges from about 0 to about 5.

In some embodiments of the method, the solvent comprises a polar organic solvent, non-polar organic solvent, or a combination thereof. In some embodiments, the solvent comprises pyridine and a second solvent. In other embodiments, the second solvent comprises an alcohol. In some embodiments, the solvent comprises ethanol, pyridine, or a combination thereof. In some embodiments, the solvent comprises xylene.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure may be understood by reference to the following detailed description taken in conjunction with the drawings briefly described below. It is noted that, for purposes of illustrative clarity, certain elements in the drawings may not be drawn to scale.

FIG. 1 shows XRD patterns of the electrolyte compositions obtained according to embodiments of the present disclosure.

### DETAILED DESCRIPTION

In the following description, specific details are provided to impart a thorough understanding of the various embodiments of the disclosure. Upon having read and understood the specification, claims, and drawings hereof, those skilled in the art will understand that some embodiments may be practiced without hewing to some of the specific details set forth herein. Moreover, to avoid obscuring the disclosure, some well-known methods, processes, devices, and systems utilized in the various embodiments described herein are not disclosed in detail.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint.

For example, the endpoint may be within 10%, 8%, 5%, 3%, 2%, or 1% of the listed value. Further, for the sake of convenience and brevity, a numerical range of “about 50 mg/ml to about 80 mg/mL” should also be understood to provide support for the range of “50 mg/mL to 80 mg/mL.” The endpoint may also be based on the variability allowed by an appropriate regulatory body, such as the FDA, USP, etc.

In this disclosure, the terms “including,” “containing,” and/or “having” are understood to mean comprising and are open ended terms.

The indefinite articles “a” and “an,” as used herein in the specification and in the claims, unless clearly indicated to the contrary, should be understood to mean “at least one.”

As used herein, the term “electrolyte” refers to a complete material suitable for use as the electrolyte in an electrochemical device. A “solid electrolyte” refers to an electrolyte in the solid state, which is suitable for use in the same state. The solid electrolyte or electrolyte may be a pure, i.e. single component material, with respect to both chemical and crystalline composition, or it may contain a mixture of components having different chemical compositions and/or crystalline structures.

As used herein, the term “composite” refers to a mixture of at least two components having distinct chemical compositions and/or crystalline structures.

### Electrolyte Composition

The current disclosure provides an electrolyte composition. The electrolyte comprises a lithium component, a phosphorus component, and a sulfur component. The electrolyte may further comprise one or more halogen components. The one or more halogen components may be fluorine, chlorine, bromine, iodine, or a combination thereof.

In some embodiments, the electrolyte may comprise Li_{5+z}P₃S₁₀X_{z}, wherein X is halogen and where 0≤z≤5. The halogen may be fluorine, chlorine, bromine, iodine, or a combination thereof.

In some embodiments, X may be chlorine. In some embodiments, the electrolyte may have a formula Li_{5+z}P₃S₁₀Cl_{z} where z may range from about 0 to about 5. For example, z may be about 0, about 0.1, about 0.2, about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, or about 5.0. In some embodiments, z may range from about 0 to about 5, about 1 to about 4, or about 2 to about 3.

In one embodiment, the electrolyte may be Li₆P₃S₁₀Cl.

In some embodiments, the electrolyte may include LiCl.

The compositions of the present disclosure may have an X-Ray Diffraction (XRD) pattern having one or more peaks expressed in degrees 2θ at 15.39°±0.5°, 27.60°±0.5°, 30.92°±0.5°, and 33.28°±0.5°. In some aspects, the compositions of the present disclosure may have an XRD pattern having two or more, three or more, four or more, or five or more peaks expressed in degrees 2θ at 15.39°±0.5°, 27.60°±0.5°, 30.92°±0.5°, and 33.28°±0.5°. Further, the composition may have one or more peaks at 11.45°±0.5°, 16.43°±0.5°, 19.33°±0.5°, and 23.02°±0.5°.

In some embodiments, the compositions of the present disclosure may have an XRD pattern having one, two, three, or four peaks selected from the group consisting of 11.45°±0.5°, 16.43°±0.5°, 19.33°±0.5°, and 23.02°±0.5°.

The electrolyte may have a unique combination of molecular formula and crystal phase. This material may also have a monoclinic C2/m (no. 12) space group as measured by XRD.

### Method of Making the Electrolyte Composition

The current disclosure provides a method of making an electrolyte composition with formula Li₅₊₂P₃S₁₀X₂, where X is a halogen and where z may be 0≤z≤5. The halogen may be fluorine, chlorine, bromine, iodine, or a combination thereof. In some embodiments, X is chlorine and LiX may be LiCl.

The method comprises mixing Li₂S, P₂S₅, sulfur, and optionally LiX in the presence of a suitable solvent and milling media. The amount of Li₂S, P₂S₅, sulfur, LiX may vary.

First Li₂S, P₂S₅, sulfur, and LiX may be placed in a milling jar. Examples of suitable milling jar materials include but are not limited to stainless steel, alumina, polyurethane, zirconia, agate, tungsten carbide, polyethylene (HDPE or LDPE), glass, carbon steel, silicon nitride, or cobalt. In some embodiments, the milling jar mater may be a zirconia (ZrO₂).

Next, milling media and a suitable solvent may be placed in the milling jar containing the reactants. Examples of suitable milling media include but are not limited to steel balls, alumina balls, polyurethane balls, zirconia balls, agate balls, tungsten carbide balls, polyethylene (HDPE or LDPE) media, glass balls, polyurethane balls, carbon steel, silicon nitride balls, cylindrical or rod-shaped media, ceramic cylindrical media, lead balls, or cemented carbide balls. In some embodiments, the milling media may be zirconia balls. In some embodiments, the zirconia balls may be 5 mm zirconia balls. The suitable solvent may be a polar organic solvent or a non-polar organic solvent. In some embodiments, the solvent may be xylene.

The milling jar containing the milling media and the reactants may be placed in a Retch planetary ball mill and milled for a specified period of time at a specified speed. The specified period of time may range from about 1 hour to about 20 hours. For example, the period of time may be about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, or about 20 hours. In one embodiment, the period of time may be 12 hours. The specified speed may range from about 100 rpm to 1,000 rpm. For example, the speed may be about 100 rpm, about 200 rpm, about 300 rpm, about 400 rpm, about 500 rpm, about 600 rpm, about 700 rpm, about 800 rpm, about 900 rpm, or about 1000 rpm. In some embodiments, the milling speed may be 500 rpm.

The solvent may be removed by placing the milling jar in a vacuum oven. The contents of the milling jay may be heated to a suitable temperature for a specified time. The suitable temperature may range from about 50° C. to about 100° C. In some embodiments, the suitable temperature may be 70° C. The specified time may range from about 30 minutes to about 120 minutes. In some embodiments, the specified time may be about 60 minutes.

Lastly, the dried material may be heated at a temperature ranging from about 200° C. to about 400° C. for a time ranging from about 30 minutes to about 120 minutes to form the crystallized electrolyte composition. The temperature may be about 200° C., about 210° C., about 220° C., about 230° C. about 240° C., about 250° C., about 260° C., about 270° C., about 280° C., about 290° C., about 300° C., about 310° C., about 320° C., about 330° C. about 340° C., about 350° C., about 360° C., about 370° C., about 380° C., about 390° C., or about 400° C., In some embodiments, the temperature may be about 200° C. In some embodiments, the temperature may be about 210° C., In other embodiments, the temperature may be about 220° C. In yet other embodiments, the temperature may be about 230° C. In other embodiments, the temperature may be about 240° C. In some embodiments, the time may be about 30minutes, 40 minutes, 50 minutes, 60 minutes, 70 minutes, 80 minutes, 90 minutes, 100 minutes, 110 minutes, or 120 minutes,

### Electrochemical Cell Containing the Solid Electrolyte Composition of the Present Disclosure

Further provided herein is a solid-state electrochemical cell comprising an anode layer, a cathode layer, and a solid-state electrolyte layer, which may be referred to as a separator layer. The solid-state electrolyte layer is disposed between the anode layer and the cathode layer. In some embodiments, the solid-state electrochemical cell further comprises a first current collector layer and a second current collector layer, wherein the first current collector layer is disposed adjacent to the anode layer and the second current collector layer is disposed adjacent to the cathode layer. In some embodiments, the solid-state electrochemical cell further comprises a first current collector layer and a second current collector layer, wherein the first current collector layer is disposed adjacent to the cathode layer and the second current collector layer is disposed adjacent to the anode layer. A complete solid-state battery will typically encase the cell stack (electrodes, separators, and current collectors) in a pouch and include a first tab (outside the pouch) electrically coupled to the current collectors for the anodes, and a second tab (also outside the pouch) electrically coupled to the current collectors for the cathodes.

Preferably, the anode layer of the electrochemical cell comprises one or more anode active materials containing lithium metal, lithium alloys, silicon, silicon alloys, graphite, carbon, tin, or a combination thereof.

The anode layer may comprise one or more conductive additives. The conductive additives may include metal powders, fibers, filaments, or any other material known to conduct electrons. In some aspects, the one or more conductive additives may include one or more conductive carbon materials such as carbon fiber, graphite, graphene, carbon black, conductive carbon, amorphous carbon, VGCF, silicon-carbon composites, or carbon nanotubes. In some aspects, the conductive additive may be present in the anode layer in an amount from about 0 wt % to about 10 wt %.

The anode layer may include the solid-state electrolyte of the present disclosure. In some embodiments, the solid-state electrolyte may be Li_{5+z}P₃S₁₀X_{z} (where “X” represents at least one halogen and where 0≤z≤5. The anode layer may further comprise an oxide, oxysulfide, sulfide, halide, nitride, or any other solid-state electrolyte known in the art. In some embodiments, the solid-state electrolyte further comprises one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—Lil, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, or Li₂S—S—SiS₂—LiₓMO_{y} (where x and y are positive numbers, and M is P, Si, Ge, B, Al, Ga or In). In another embodiment, the solid-state electrolyte may be selected from the group consisting of one or more of a Li₃PS₄, Li₄P₂S₆, Li₇P₃S₁₁, Li₁₀GeP₂S₁₂, and Li₁₀SnP₂S₁₂. In a further embodiment, the solid-state electrolyte may be selected from the group consisting of one or more of a Li₆PS₅Cl, Li₆PS₅Br, and Li₆PS₅I or may expressed by the formula Li_{7-y}PS_{6-y}X_{y} where “X” represents at least one halogen and/or at least one pseudo-halogen, where 0<y≤2.0, and where the at least one halogen may be one or more of F, Cl, Br, I, and the at least one pseudo-halogen may be one or more of N, NH, NH₂, NO, NO₂, BF₄, BH₄, AlH₄, CN, or SCN. In yet another embodiment, the solid-state electrolyte may be expressed by the formula Li_{8-y-z}P₂S_{9-y-z}X_{y}W_{z} (where “X” and “W” represents at least one halogen elements and or pseudo-halogen and where 0≤y≤1 and 0≤z≤1) and where a halogen may be one or more of F, CI, Br, I, and a pseudo-halogen may be one or N, NH, NH₂, NO, NO₂, BF₄, BH₄, AlH₄, CN, and SCN. In some aspects, the solid state electrolyte may be present in the anode layer in an amount from about 0 wt % to about 20 wt %.

The anode layer may comprise a binder. In some embodiments, the binder may include a fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR), and the like. In a further embodiment, the binder may be one or more of an acrylic resin such as but not limited to polymethyl (meth) acrylate, polyethyl (meth)acrylate, polyisopropyl (meth)acrylate polyisobutyl (meth)acrylate, polybutyl (meth)acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), ethylene propylene diene monomer rubber (EPDM), and mixtures thereof. In some aspects, the binder may be present in the anode layer in an amount from about 0 wt % to about 5 wt %.

The cathode layer may comprise a cathode active material such as an NMC type cathode active material comprising at least nickel, manganese, and cobalt which can be expressed as, e.g., Li(NiₐCo_{b}Mn_{c})O₂(0<a<1, 0<b<1, 0<c<1, a+b+c=1), NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn0.2Co_{0.2}O₂), NMC 811 (LiNi_{0.8}Mn_{0.1}Co_{0.1}O₂), or a combination thereof. In some aspects, the cathode active material may comprise one or more of a coated or uncoated metal oxide, such as but not limited to V₂O₅, V₆O₁₃, MoO₃, LiCoO₂, LiNiO₂, LiMnO₂, LiMn₂O₄, LiNi_{1-Y}CO_{Y}O₂, LiCo_{1-Y}Mn_{Y}O₂, LiNi_{1-Y}Mn_{Y}O₂(0≤Y<1), Li(NiₐCo_{b}Mn_{c})O₄(0<a<2, 0<b<2, 0<c<2, a+b+c=2), LiMn_{2-Z}Ni_{Z}O₄, LiMn_{2-Z}CO_{Zz}O₄(0<Z<2), LiCoPO₄, LiFePO₄, CuO, or Li(NiₐCo_{b}Al_{c})O₂(0<a<1, 0<b<1, 0<c<1, a+b+c=1). In other embodiments, the cathode active material may comprise one or more of a coated or uncoated metal sulfide such as but not limited to titanium sulfide (TiS₂), molybdenum sulfide (MoS₂), iron sulfide (FeS, FeS₂), copper sulfide (CuS), or nickel sulfide (Ni₃S₂). In another embodiment, the cathode active material may comprise one or more of a metal fluoride, such as but not limited to iron fluoride (FeF₂, FeF₃), copper fluoride (CuF₂), zinc fluoride (ZnF₂), titanium fluoride (TiF₄), or nickel fluoride (NiF₂).

The cathode layer may comprise one or more conductive additives. The conductive additives may include metal powders, fibers, filaments, or any other material known to conduct electrons. In some aspects, the one or more conductive additives may include one or more conductive carbon materials such as carbon fiber, graphite, graphene, carbon black, conductive carbon, amorphous carbon, VGCF, silicon-carbon composites, or carbon nanotubes. In some aspects, the conductive additive may be present in the cathode layer in an amount from about 1 wt % to about 10 wt %.

The cathode layer may include the solid-state electrolyte of the present disclosure. In some embodiments, the solid-state electrolyte may be Li₅₊₂P₃S₁₀X_{z} (where “X” represents at least one halogen and where 0≤z≤5.The cathode layer may further comprise an oxide, oxysulfide, sulfide, halide, nitride, or any other solid-state electrolyte known in the art. In some embodiments, the solid-state electrolyte further comprises one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, or Li₂S—S—SiS₂—LiₓMO_{y} (where x and y are positive numbers, and M is P, Si, Ge, B, Al, Ga or In). In another embodiment, the solid-state electrolyte may be selected from the group consisting of one or more of a Li₃PS₄, Li₄P₂S₆, Li₇P₃S₁₁, Li₁₀GeP₂S₁₂, and Li₁₀SnP₂S₁₂. In a further embodiment, the solid-state electrolyte may be selected from the group consisting of one or more of a Li₆PS₅Cl, Li₆PS₅Br, and Li₆PS₅ or may expressed by the formula Li_{7-y}PS_{6-y}X_{y} where “X” represents at least one halogen and/or at least one pseudo-halogen, where 0<y≤2.0, and where the at least one halogen may be one or more of F, Cl, Br, I, and the at least one pseudo-halogen may be one or more of N, NH, NH₂, NO, NO₂, BF₄, BH₄, AlH₄, CN, or SCN. In yet another embodiment, the solid-state electrolyte may be expressed by the formula Li_{8-y-z}P₂S_{9-y-z}X_{y}W_{z} (where “X” and “W” represents at least one halogen elements and or pseudo-halogen and where 0≤y≤1 and 0≤z≤1) and where a halogen may be one or more of F, CI, Br, I, and a pseudo-halogen may be one or N, NH, NH₂, NO, NO₂, BF₄, BH₄, AlH₄, CN, and SCN. In some aspects, the solid state electrolyte may be present in the cathode layer in an amount from about 5 wt % to about 20 wt %.

The cathode layer may comprise a binder. In some embodiments, the binder may include a fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR), and the like. In a further embodiment, the binder may be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), ethylene propylene diene monomer rubber (EPDM), and mixtures thereof. In some aspects, the binder may be present in the cathode layer in an amount from about 0 wt % to about 5 wt %.

The electrolyte layer (also referred to herein as the “separator layer”) may comprise the solid-state electrolyte of the present disclosure. In some embodiment, the solid-state electrolytes may comprise an oxide, oxysulfide, sulfide, halide, nitride, or any other solid-state electrolyte known in the art. In further embodiments, the solid-state electrolytes may comprise a sulfide solid-state electrolyte. In some aspects, the sulfide solid-state electrolyte may be an argyrodite material. In some aspects, the one or more sulfide solid-state electrolytes may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, or Li₂S—S—SiS₂—LiₓMO_{y} (where x and y are positive numbers, and M is P, Si, Ge, B, Al, Ga or In). In some embodiments, one or more of the solid electrolyte materials may be Li₃PS₄, Li₄P₂S₆, Li₇P₃S₁₁, Li₁₀GeP₂S₁₂, Li₁₀SnP₂S₁₂, or combinations thereof. In another embodiment, one or more of the solid electrolyte materials may be Li₆PS₅Cl, Li₆PS₅Br, Li₆PS₅I or may be expressed by the formula Li_{7-y}PS_{6-y}X_{y}, where “X” represents at least one halogen and/or at least one pseudo-halogen, where 0<y≤2.0, and where the halogen may be one or more of F, CI, Br, I, or combinations thereof, and the pseudo-halogen may be one or more of N, NH, NH₂, NO, NO₂, BF₄, BH₄, AlH₄, CN, SCN, or combinations thereof. In another embodiment, one or more of the solid electrolyte materials may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, or I, and the pseudo-halogen may be one or more of N, NH, NH₂, NO, NO₂, BF₄, BH₄, AIH₄, CN, SCN, or combinations thereof.

The electrolyte layer may further comprise a binder. In some embodiments, the binder may include a fluororesin containing vinylidene fluoride (VdF), hexafluoropropylene (HFP), tetrafluoroethylene (TFE), or derivatives thereof as structural units. Specific examples thereof may include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer, such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR) and the like. In a further embodiment, the binder may be one or more of an acrylic resin such as but not limited to polymethyl(meth)acrylate, polyethyl(meth)acrylate, polyisopropyl(meth)acrylate polyisobutyl(meth)acrylate, polybutyl(meth)acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), ethylene propylene diene monomer rubber (EPDM), and mixtures thereof. In some aspects, the binder may be present in the electrolyte layer in an amount from about 0% to about 20% by weight.

In some embodiments, the electrolyte layer may have a thickness from about 10 um to about 40 μm. In some aspects, the electrolyte layer may have a thickness from about 10 μm to about 20 μm, about 10 μm to about 30 μm, about 20 μm to about 30 μm, about 20 um to about 40 μm, or about 30 μm to about 40 μm. In some additional aspects, the electrolyte layer may have a thickness of about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 um, about 28 μm, about 29 μm, about 30 μm, about 31 μm, about 32 μm, about 33 μm, about 34 μm, about 35 μm, about 36 μm, about 37 μm, about 38 μm, about 39 μm, or about 40 μm.

The first current collector and the second current collector may comprise one or more of copper, aluminum, nickel, titanium, stainless steel, magnesium, iron, zinc, indium, germanium, silver, platinum, or gold. The current collector may further comprise a carbon coating on a side of the current collector adjacent to the composite anode or the cathode layer. In some embodiments, the first current collector or the second current collector may have a thickness from about 5 μm to about 10 μm. In preferred embodiments, the first current collector comprises copper, nickel, and/or steel.

The disclosure will now be illustrated with working examples, and which are intended to illustrate the disclosure and not intended to restrict any limitations on the scope of the present disclosure. Unless defined otherwise, all technical and scientific terms used herein have the same meaning as commonly understood to one of ordinary skill in the art to which this disclosure belongs.

### EXAMPLES

### Example 1

8.45 g of LiCl, 2.29 g of Li₂S, 11.07 g of P2S5, and 3.19 g of elemental sulfur were placed in a 250 ml ZrO₂ mill jar. 400 g of 5 mm ZrO₂ media was placed in the same jar all with 60 ml of xylenes. The mill jar was then placed in a Retch planetary ball mill and milled for 12 hours at 500 rpm. After, the solvent was removed by placing the milling jar containing the milled material in a vacuum oven where the material was heated to 70° C. for 60 minutes while under vacuum conditions. An aliquot of the dried material was then heated to 240° C. for one hour to form the crystallized electrolyte of Example 1.

### Example 2

Example 2 was conducted in the same manner as Example 1 except the materials used were 5.08 g of LiCl, 2.75 g of Li₂S, 13.32 g of P₂S₅, and 3.84 g of elemental sulfur. An aliquot of the dried material was then heated to 240° C. for one hour to form the crystallized electrolyte of Example 2.

### Example 3

Example 3 was conducted in the same manner as Example 1 except the materials used were 1.42 g of LiCl, 3.26 g of Li2S, 15.77 g of P₂S₅, and 4.55 g of elemental sulfur. An aliquot of the dried material was then heated to 220° C. for one hour to form the crystallized electrolyte of Example 3.

### Example 4

Example 4 was conducted in the same manner as Example 1 except the materials used were 1.54 g of LiCl, 3.51, g of Li₂S, 15.05 g of P₂S₅, and 4.90 g of elemental sulfur. An aliquot of the dried material was then heated to 220° C. for one hour to form the crystallized electrolyte of Example 4.

### Example 5

Example 5 was conducted in the same manner as Example 1 except the materials used were 2.20 g of LiCl, 5.03 g of Li₂S, 10.76 g of P₂S₅, and 7.02 g of elemental sulfur. An aliquot of the dried material was then heated to 240° C. for one hour to form the crystallized electrolyte of Example 5

### Example 6

Example 6 was conducted in the same manner as Example 1 except the materials used were 1.90 g of LiCl, 4.36 g of Li₂S, 12.65 g of P₂S₅, and 6.08 g of elemental sulfur. An aliquot of the dried material was then heated to 240° C. for one hour to form the crystallized electrolyte of Example 6.

### Example 7

Example 7 was conducted in the same manner as Example 1 except the materials used were 3.74 g of Li₂S, 16.03 g of P₂S₅, and 5.23 g of elemental sulfur. An aliquot of the dried material was then heated to 240° C. for one hour to form the crystallized electrolyte of Example 7.

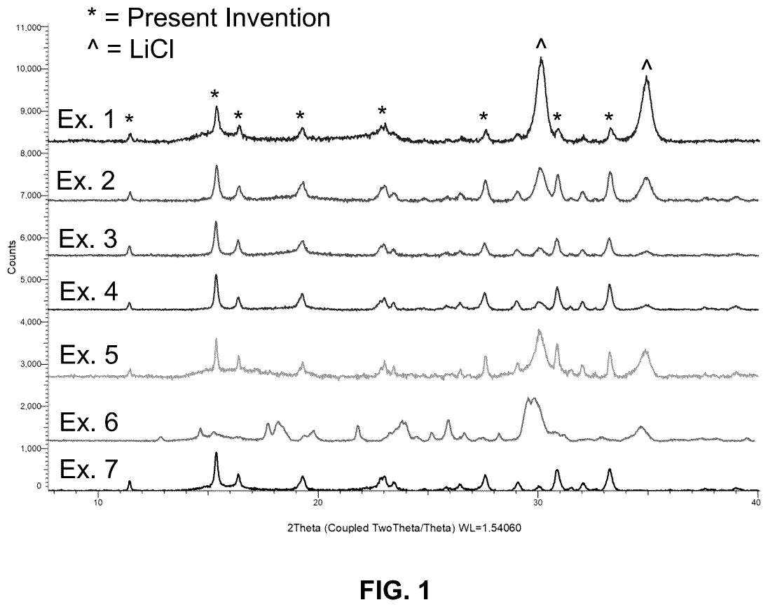

FIG. 1 shows the X-ray diffraction pattern of the electrolytes of Examples 1 to 7.

Features described above as well as those claimed below may be combined in various ways without departing from the scope hereof. It should thus be noted that the matter contained in the above description or shown in the accompanying drawings should be interpreted as illustrative and not in a limiting sense. The above-described embodiments should be considered as examples of the present invention, rather than as limiting the scope of the invention. In addition to the foregoing embodiments of inventions, review of the detailed description and accompanying drawings will show that there are other embodiments of such inventions. Accordingly, many combinations, permutations, variations and modifications of the foregoing embodiments of inventions not set forth explicitly herein will nevertheless fall within the scope of such inventions. The following claims are intended to cover generic and specific features described herein, as well as all statements of the scope of the present method and system, which, as a matter of language, might be said to fall there between.

What is claimed is:

1. An electrolyte composition comprising lithium, phosphorous, and sulfur; wherein the electrolyte comprises an x-ray diffraction (XRD) peak at 2θ=15.39°±0.5°, 27.60°±0.5°, 30.92°±0.5°, or 33.28°±0.5°.

2. The composition of claim 1, wherein the composition exhibits an XRD pattern having peaks at 2θ=15.39°±0.5°, 27.60°±0.5°, 30.92°±0.5°, and 33.28°±0.5°.

3. The composition of claim 1, further comprising a halogen and formula Li_{5+z}P₃S₁₀X_{z}, where 0≤z≤5; wherein X is F, Cl, Br, or I.

4. The composition of claim 3, wherein X is Cl comprising the formula Li_{5+z}P₃S₁₀Cl_{z}, where 0≤z≤5.

5. The composition of claim 1, wherein the composition comprises an XRD peak 2θ at one or more of 11.45°±0.5°, 16.43°±0.5°, 19.33°±0.5°, and 23.02°±0.5°.

6. The composition of claim 1, wherein the composition comprises an XRD peak 2θ at two or more of 11.45°±0.5°, 16.43°±0.5°, 19.33°±0.5°, and 23.02°±0.5°.

7. The composition of claim 1, wherein the composition comprises an XRD peak 2θ at three or more of 11.45°±0.5°, 16.43°±0.5°, 19.33°±0.5°, and 23.02°±0.5°.

8. The composition of claim 1, wherein the composition comprises an XRD peak 2θ at 11.45°±0.5°, 16.43°±0.5°, 19.33°±0.5°, and 23.02°±0.5°.

9. The composition of claim 1, wherein the composition comprises an XRD peak 2θ at one or more of 15.39°±0.5°, 27.60°±0.5°, 30.92°±0.5°, and 33.28°±0.5°.

10. The composition of claim 1, wherein the composition comprises an XRD peak 2θ at two or more of 15.39°±0.5°, 27.60°±0.5°, 30.92°±0.5°, and 33.28°±0.5°.

11. The composition of claim 1, wherein the composition comprises an XRD peak 2θ at three or more of 15.39°±0.5°, 27.60°±0.5°, 30.92°±0.5°, and 33.28°±0.5°.

12. The composition of claim 1, wherein the electrolyte comprises an XRD peak at 2θ=11.45°±0.5°.

13. The composition of claim 1, wherein the electrolyte comprises an XRD peak at 2θ=16.43°±0.5°.

14. The composition of claim 1, wherein the electrolyte comprises an XRD peak at 2θ=19.33°±0.5°.

15. The composition of claim 1, wherein the electrolyte comprises an XRD peak at 2θ=23.02°±0.5°.

16. The composition of claim 1, wherein the composition comprises an XRD peak at 2θ=15.39°±0.3°, 27.60°±0.3°, 30.92°±0.3°, and 33.28°±0.3°.

17. The composition of claim 1, wherein the composition comprises an XRD peak 2θ at one or more of 11.45°±0.3°, 16.43°±0.3°, 19.33°±0.3°, and 23.02°±0.3°.

18. The composition of claim 1, wherein the composition comprises an XRD peak at 2θ=15.39°±0.1°, 27.60°±0.1°, 30.92°±0.1°, and 33.28°±0.1°.

19. The composition of claim 1, wherein the composition comprises an XRD peak 2θ at one or more of 11.45°±0.1°, 16.43°±0.1°, 19.33°±0.1°, and 23.02°±0.1°.

20. The composition of claim 1, wherein the electrolyte further comprises LiCl.

21. A method of making an electrolyte composition comprising lithium, phosphorous, and sulfur with formula Li_{5+z}P₃S₁₀X_{z}, the method comprising mixing Li₂S, P₂S₅, sulfur, and LiX, wherein X is a halogen and 0≤z≤5.
